(19) United States
(12) Patent Application Publication
(10) Pub. No.: US 2020/0113411 A1
(43) Pub. Date: Apr. 16, 2020

(54) DUST SUCTIONING AIR MAT PROVIDED WITH AIR INFLOW VALVE

(71) Applicants: Dong Jun SHIN, Ansan-si, Gyeonggi-do (KR); TESTONIC CO., LTD., Siheung-si, Gyeonggi-do (KR)

(72) Inventor: Dong Jun SHIN, Ansan-si (KR)

(21) Appl. No.: 16/603,892

(22) PCT Filed: Dec. 8, 2017
(86) PCT No.: PCT/KR2017/014377

§ 371 Date: Oct. 9, 2019

(30) Foreign Application Priority Data
Apr. 13, 2017 (KR) 10-2017-0047695

(51) Int. Cl. A47L 23/26; B08B 5/04; F16K 15/14; F16K 27/02

(52) U.S. Cl. CPC A47L 23/263; A47L 23/266; F16K 27/0209; F16K 15/14; B08B 5/04

(57) ABSTRACT

A dust suctioning air mat with an air inflow valve includes: a main body composed of a bottom plate and a footboard installed on an upper part of the bottom plate, the bottom plate having a dust suction part formed therein to suck dust, and having an air inflow groove formed in one side thereof to communicate with the outside, and the footboard having suction holes through which dust can be sucked in formed therein; an air inflow valve which is installed in the air inflow groove of the bottom plate, allows the inflow of outside air, and can control the inflow amount of the air, and an elastic part which is installed inside the bottom plate and provides elastic force for opening and closing the suction holes.

### BACKGROUND

### 1. Technical Field

The present invention relates to a dust suction air mat with an air inflow valve, and more particularly, to a dust suction air mat with an air inflow valve that is capable of controlling an amount of air introduced from the outside according to a weight stepped on a footboard and a location on which the footboard is stepped, thereby enhancing a dust suction rate to maximize a dust removal efficiency.

### 2. Description of Related Art

In facilities such as factories, hospitals, and stores, generally, dust attached to shoes of a person who is accessed to the facility is removed to provide clean indoor environments.

As all kinds of devices such as computers, electronics, and so on, which are influenced by dust, have been spread out, recently, a need for removing dust has been increased even in general houses and buildings.

So as to especially protect residents in a building from yellow sand, these days, the residents have to remove dust from their shoes when they come inside from outside.

With the above-mentioned reasons, various dust suction devices have been suggested, and for example, a dust suction device for shoes is disclosed in Korean Patent No.10-1198142 (hereinafter, referred to as ‘Patent document 1’), and the dust suction device includes a housing having a plurality of suction holes formed on top thereof, a suction part for transferring a suction force to an interior of the housing to allow foreign matters like dust to be sucked to the suction holes, and elastically operating members for opening or closing the suction holes of the housing to selectively transfer a suction pressure from the suction part, wherein the elastically operating members adjacent to each other under the housing are fastened to bundles by means of unit fastening means, and if any one among the elastically operating members fastened through the unit fastening means is pressurized, other elastically operating members fastened to the elastically operating member pressurized are simultaneously operated.

According to the Patent document 1, if heads exposed to the outside from the housing are stepped, upward and downward lengths of the elastically operating members are reduced to allow the heads to be descended, so that the suction holes are open. In this case, however, the suction holes are open in spaces defined by the outer peripheral surfaces of the heads and the inner peripheral surfaces thereof, so that they cannot be completely open, thereby undesirably limiting an amount of dust sucked to the housing.

According to the Patent document 1, further, it is hard to allow the suction force generated from the suction part to be transferred to a portion distant from the suction part at the time when the dust descended from the shoes through the suction holes is sucked through the suction part, and besides, the elastically operating members are disposed inside the housing, an interference occurs due to a flow of air, thereby decreasing a dust suction efficiency to the suction part.

### SUMMARY

### Technical Problem

Accordingly, the present invention has been made in view of the above-mentioned problems occurring in the prior art, and it is an object of the present invention to provide a dust suction air mat that is configured to have an air inflow valve disposed at a corner of one side of a main body sucking dust to introduce outside air to the main body and to control an amount of air introduced and configured to have a plurality of partition walls formed inside the main body to form a flow path therein, thereby maximizing a dust suction efficiency, having no dust remaining therein to require no cleaning, and providing many conveniences for a user.

### Technical Solution

To accomplish the above-mentioned object, according to the present invention, there is provided a dust suction air mat including: a main body having a bottom plate and a footboard disposed on top of the bottom plate, the bottom plate having a dust suction portion formed therein to suck dust and an air inflow groove formed in one side thereof to communicate with the outside, and the footboard having suction holes through which dust is sucked; an air inflow valve disposed in the air inflow groove of the bottom plate to introduce outside air and control an amount of air introduced; and elastic parts disposed inside the bottom plate to provide elastic forces for opening and closing the suction holes.

According to the present invention, desirably, the bottom plate has a plurality of partition walls disposed at the inside thereof to form a flow path in the dust suction portion.

According to the present invention, desirably, the partition walls are misalignedly spaced apart from each other to allow the flow path to have a zigzag shape.

According to the present invention, desirably, the air inflow groove is formed on a diagonal line at the longest distance with respect to a connection hose connected to a suction part for sucking the dust.

According to the present invention, desirably, the air inflow valve includes: first and second valve bodies disposed at the inside and outside of the air inflow groove of the bottom plate; and a control member disposed between the first and second valve bodies to control the amount of air introduced.

According to the present invention, desirably, the first and second valve bodies are fixed to each other by means of bolts and nuts, while placing the control member therebetween.

According to the present invention, desirably, the control member has a control plate disposed on the center thereof in such a manner as to be rotated to the inside and outside of the air inflow groove to introduce the outside air and control the amount of outside air introduced.

### Advantageous Effects

According to the present invention, the dust suction air mat is provided with the air inflow valve disposed at a corner of one side of the bottom plate sucking foreign matters like dust, sand and so on to introduce outside air and with the plurality of partition walls formed on the bottom plate to form the zigzag flow path, so that the air inflow valve is controlled according to a degree of weight for stepping the footboard, thereby maximizing a dust suction efficiency.

### BRIEF DESCRIPTION OF DRAWINGS

FIG. 1 is an exploded perspective view showing a dust suction air mat with an air inflow valve according to the present invention.

FIG. 2 is a perspective view showing the dust suction air mat with an air inflow valve according to the present invention.

FIG. 3 is an exploded perspective view showing the air inflow valve of the dust suction air mat according to the present invention.

FIG. 4 is a perspective view showing the air inflow valve of the dust suction air mat according to the present invention.

FIG. 5 is a sectional view showing an operating state of the air inflow valve of the dust suction air mat according to the present invention.

### DETAILED DESCRIPTION OF THE INVENTION

The present invention may be modified in various ways and may have several exemplary embodiments. Specific exemplary embodiments of the present invention are illustrated in the drawings and described in detail in the detailed description. However, this does not limit the invention within specific embodiments and it should be understood that the invention covers all the modifications, equivalents, and replacements within the idea and technical scope of the invention.

In the description, the thicknesses of the lines or the sizes of the components shown in the drawing may be magnified for the clarity and convenience of the description. Further, the terms as will be discussed later are defined in accordance with the functions of the present invention, but may be varied under the intention or regulation of a user or operator. Therefore, they should be defined on the basis of the whole scope of the present invention.

In the description, a term ‘and/or’ includes a combination of a plurality of relevant and described items or any one of a plurality of related and described items. When it is said that one element is described as being “connected” or “coupled” to the other element, one element may be directly connected or coupled to the other element, but it should be understood that another element may be present between the two elements. An expression referencing a singular value additionally refers to a corresponding expression of the plural number, unless explicitly limited otherwise by the context. In this application, terms, such as “comprise”, “include”, or ‘have”, are intended to designate those characteristics, numbers, steps, operations, elements, or parts which are described in the specification, or any combination of them that exist.

Hereinafter, the present invention is disclosed with reference to the attached drawings.

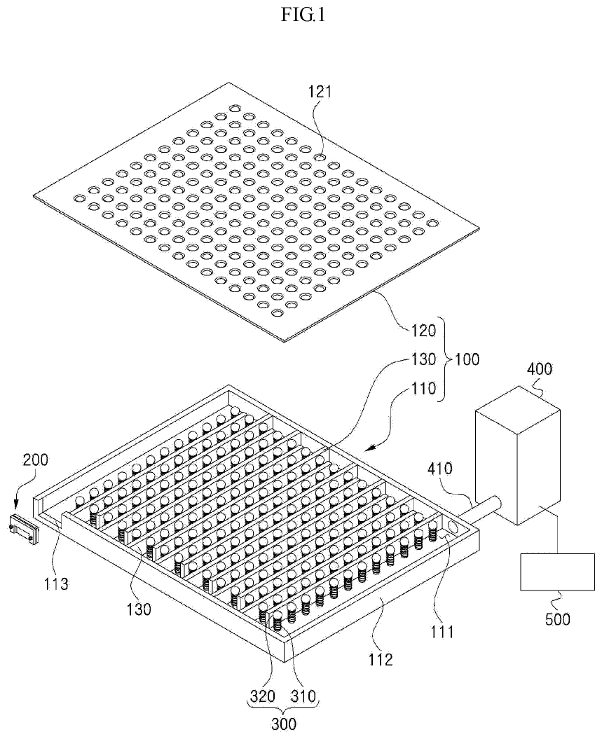

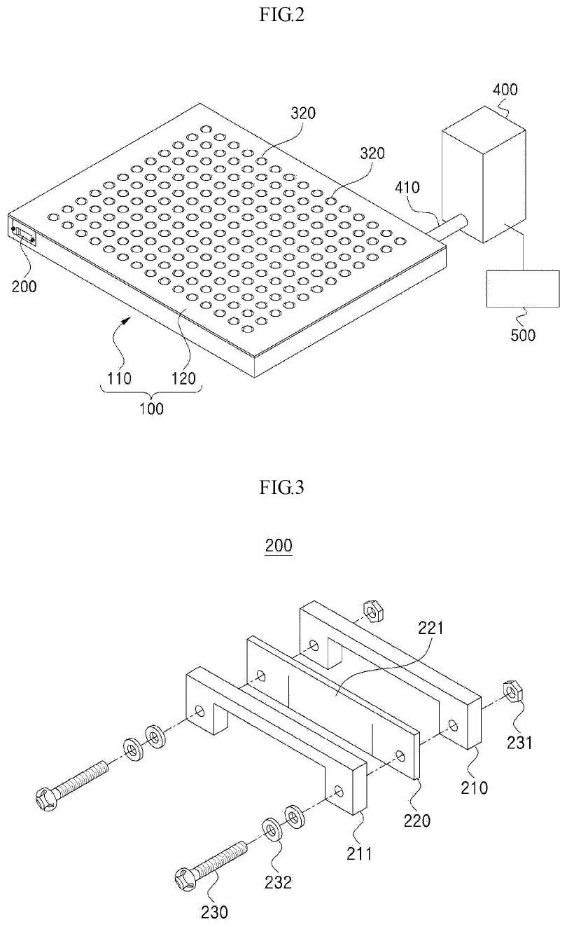

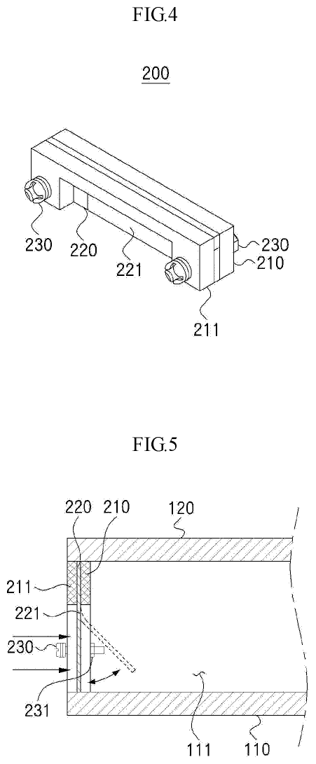

FIG. 1 is an exploded perspective view showing a dust suction air mat with an air inflow valve according to the present invention, FIG. 2 is a perspective view showing the dust suction air mat with an air inflow valve according to the present invention, FIG. 3 is an exploded perspective view showing the air inflow valve of the dust suction air mat according to the present invention, FIG. 4 is a perspective view showing the air inflow valve of the dust suction air mat according to the present invention, and FIG. 5 is a sectional view showing an operating state of the air inflow valve of the dust suction air mat according to the present invention.

As shown in FIGS. 1 to 4, first, the dust suction air mat according to the present invention includes a main body 100, an air inflow valve 200, elastic parts 300, and a suction part 400.

As shown in FIG. 1, the main body 100 includes a bottom plate 110 and a footboard 120 disposed on top of the bottom plate 110 in such a manner as to be stepped by a person or vehicle with access.

The bottom plate 110 is laid on the floor of a gateway and has a dust suction portion 111 formed therein to suck foreign matters like dust, sand and so on.

Also, the bottom plate 110 has a finishing part 112 protruding upward along the outer edges thereof to form a space for the dust suction portion 111 sucking the foreign matters like dust, sand and so on and to seat the footboard 120 thereonto.

Further, the bottom plate 110 has an air inflow groove 113 formed at a corner of one side of the finishing part 112 in such a manner as to communicate with the outside.

The air inflow groove 113 is formed on a diagonal line at the longest distance with respect to a connection hose 410 connected to the suction part 400 for sucking the dust, thereby removing a blind spot in the dust suction.

Furthermore, the bottom plate 110 has a plurality of partition walls 130 disposed on a bottom surface thereof to form a flow path in the dust suction portion 111.

The partition walls 130 are misalignedly spaced apart from each other to remove a blind spot in discharging the foreign matters like dust, sand and so on.

In detail, the partition walls 130 are misaligned with each other on the bottom plate 110 to form a zigzag flow path on the dust suction portion 111, so that since there is no blind spot, dust can be evenly discharged.

The footboard 120 is disposed on top of the bottom plate 110 in such a manner as to allow the underside thereof to be mounted on top of the finishing part 112 to form the space for the dust suction portion 111.

Moreover, the footboard 120 has suction holes 121 formed on top thereof to suck the foreign matters like dust, sand and so on attached to shoes or a vehicle's wheels to the dust suction portion 111 when the shoes or vehicle's wheels are stepped on the footboard 120.

At this time, the suction holes 121 are spaced apart from each other at given intervals on the entire area of the footboard 120.

In detail, the footboard 120 is disposed on top of the bottom plate 110 laid on the floor of a facility, to a given height by means of the finishing part 112 forming the space for the dust suction portion 111 between the bottom plate 110 and the footboard 120, and through the suction holes 121 formed on the footboard 120, the foreign matters like dust, sand and so on attached to the shoes or vehicle's wheels are sucked to the dust suction portion 111 by means of the operation of the suction part 400.

The air inflow valve 200 is disposed on the air inflow groove 113 of the bottom plate 110 to allow outside air to be introduced to the dust suction portion 111 and to control an amount of air introduced, so that a dust suction efficiency can be improved.

As shown in FIGS. 3 to 5, the air inflow valve 200 includes a first valve body 210 and a second valve body 211 disposed at the inside and outside of the air inflow groove 113 of the bottom plate 110 in such a manner as to be connected to each other and a control member 220 disposed between the first valve body 210 and the second valve body 211 to introduce outside air and to control the amount of air introduced.

The first valve body 210 and the second valve body 211 are fixed to each other by means of bolts 230 and nuts 231, while placing the control member 220 therebetween.

When the bolts 230 are fastened to the first valve body 210 and the second valve body 211, further, washers 232 are fitted to the bolts 230.

The control member 220 has a control plate 221 disposed on the center thereof in such a manner as to be rotated to the inside and outside of the air inflow groove 113 to control the amount of outside air introduced.

In detail, rotating angles of the control plate 221 are varied according to stepped degrees of the footboard 120 to control the amount of outside air introduced, so that the foreign matters like dust, sand and so on, which are sucked to the dust suction portion 111, can be gently discharged.

If the footboard 120 is strongly stepped, the air inflow valve 200 is a little open, but if the footboard 120 is slightly stepped, the air inflow valve 200 is a lot open. For example, if the footboard 120 is stepped by 100%, a large suction force for sucking dust or sand has to be needed, so that the air inflow valve 200 is a little open by 10%, and if the footboard 120 is stepped by 50%, the air inflow valve 200 is a little open by 50%. Alternatively, even if the stepped degrees of the footboard 120 are different from each other, a given air pressure can be maintained at the time of air suction and discharge.

While the footboard 120 is being not stepped, further, the air inflow valve 200 is open by 100% periodically to discharge large dust or sand in the bottom plate 110, thereby completely cleaning the interior of the dust suction air mat and sucking and filtering air around the dust suction air mat.

The elastic parts 300 are disposed inside the bottom plate 110, and each elastic part 300 includes an elastic spring 310 and an opening and closing ball 320 disposed on top of the elastic spring 310 in such a manner as to be supported elastically against the elastic spring 310 to open and close the corresponding suction hole 121.

The suction part 400 is connected to the side of the main body 100 by means of the connection hose 410, so that if shoes of a person with access pressurize the opening and closing balls 320 of the elastic parts 300 to allow the opening and closing balls 320 to be descended to open the suction holes 121, the foreign matters like dust, sand and so on attached to the shoes are sucked to the dust suction portion 111 through the suction holes 121.

Further, the suction part 400 is electrically connected to a controller 500 and is thus operated by means of a control signal of the controller 500 to allow the foreign matters like dust, sand and so on sucked to the dust suction portion 111 to be sucked to the dust suction portion 111 through the suction holes 121. The controller 500 is electrically connected to a sensor (not shown) disposed on the footboard 120 to sense a weight generated at the time when the footboard 120 is stepped and thus receives a sensed signal from the sensor to control power of the suction part 400.

Now, an explanation on an operating state of the dust suction air mat with the air inflow valve according to the present invention will be given.

If the footboard 120 is stepped by means of a person with access in a state where the main body 100 is disposed on the floor of the gateway of the facility, the opening and closing balls 320 of the elastic parts 300 are descended by means of the load applied from the person, and accordingly, the suction holes 121 are open.

If the suction holes 121 are open, the suction part 400 is operated to allow the foreign matters like dust, sand and so on attached to his or her shoes to be introduced to the dust suction portion 111 through the suction holes 121.

If the dust or sand is introduced to the dust suction portion 111, also, the suction part 400 is operated to allow the dust or sand sucked to the dust suction portion 111 to be filtered to a filter or dust collector (not shown).

If the shoes stepped on the footboard 120 are isolated from the footboard 120, contrarily, the opening and closing balls 320 of the elastic parts 300 are ascended by means of the elastic forces of the elastic springs 310, and accordingly, the suction holes 121 are closed again.

A degree of openness of the air inflow valve 200 is controlled according to a weight for stepping the footboard 120 or a location on which the footboard 120 is stepped, thereby maximizing a suction force for the foreign matters like dust, sand and so on sucked to the dust suction portion 111 to achieve an improvement in suction efficiency.

Additionally, outside air can be sucked through the air inflow valve 200, which enables air around the dust suction air mat to be sucked and filtered, thereby improving an air purifying efficiency.

Further, the partition walls 130 are disposed on the inner bottom surface of the bottom plate 110 to form the zigzag flow path on the dust suction portion 111, so that the blind spot cannot exist, irrespective of the suction positions of the foreign matters like dust, sand and so on sucked to the dust suction portion 111, thereby perfectly cleaning the dust suction portion 111.

As mentioned above, the preferred embodiment of the present invention has been disclosed in the specification and drawings. In the description of the present invention, special terms are used not to limit the present invention and the scope of the present invention as defined in claims, but just to explain the present invention.

Therefore, persons skilled in the relevant art can appreciate that many modifications and variations are possible in light of the above teachings. It is therefore intended that the scope of the invention be limited not by this detailed description, but rather by the claims appended hereto.

1. A dust suction air mat comprising:
a main body having a bottom plate and a footboard disposed on top of the bottom plate, the bottom plate having a dust suction portion formed therein to suck dust and an air inflow groove formed in one side thereof to communicate with the outside, and the footboard having suction holes through which dust is sucked;
an air inflow valve disposed in the air inflow groove of the bottom plate to introduce outside air and control an amount of air introduced; and
elastic parts disposed inside the bottom plate to provide elastic forces for opening and closing the suction holes.

2. The dust suction air mat according to claim 1, wherein the bottom plate has a plurality of partition walls disposed at the inside thereof to form a flow path in the dust suction portion.

3. The dust suction air mat according to claim 2, wherein the partition walls are misalignedly spaced apart from each other to allow the flow path to have a zigzag shape.

4. The dust suction air mat according to claim 1, wherein the air inflow groove is formed on a diagonal line at the longest distance with respect to a connection hose connected to a suction part for sucking the dust.

5. The dust suction air mat according to claim 1, wherein the air inflow valve comprises:
first and second valve bodies disposed at the inside and outside of the air inflow groove of the bottom plate; and
a control member disposed between the first and second valve bodies to control the amount of air introduced.

6. The dust suction air mat according to claim 5, wherein the first and second valve bodies are fixed to each other by means of bolts and nuts, while placing the control member therebetween.

7. The dust suction air mat according to claim 5, wherein the control member has a control plate disposed on the center thereof in such a manner as to be rotated to the inside and outside of the air inflow groove to introduce the outside air and control the amount of outside air introduced.
